(19) United States
(12) Patent Application Publication
(10) Pub. No.: US 2007/0274225 A1
(43) Pub. Date: Nov. 29, 2007

(54) ELECTRONIC COMMERCE TRANSACTION AUDIT SYSTEM, ELECTRONIC COMMERCE TRANSACTION AUDIT METHOD, AND STORAGE MEDIUM RECORDING ELECTRONIC COMMERCE TRANSACTION AUDIT PROGRAM THEREON

(75) Inventor: Shinji KIKUCHI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/834,990

(22) Filed: Aug. 7, 2007

Related U.S. Application Data
(62) Division of application No. 09/964,498, filed on Sep. 28, 2001.

(30) Foreign Application Priority Data
Sep. 29, 2000 (JP) 2000-298939

(51) Int. Cl. H04L 1/00

(52) U.S. Cl. 370/248

(57) ABSTRACT

The present invention comprises agent for gathering transaction log means for automatically collecting all exchange messages notarized and recorded depressively by a plurality of electronic notarize means in connection with the electronic commerce transaction so as to reproduce them as an event of the entire wide network area, agent for gathering protocol standards means for automatically collecting protocols of the specifications on the electronic commerce transaction, whereby correctly grasping an event to be generated in the entire wide network area, and a log analysis engine for comparing the event of the entire wide network area reproduced by the agent for gathering transaction log means with the event to be generated in the entire wide network area grasped by the agent for gathering protocol standards means, whereby carrying out an objective audit.

### BACKGROUND OF THE INVENTION

1. Field of the Invention

The present invention relates to an electronic commerce transaction audit system, electronic commerce transaction audit method, and storage medium recoding an electronic commerce transaction audit program thereon.

2. Description of the Related Art

Unexamined Japanese Patent KOKAI Publication No. H10-93557 describes a communication audit apparatus and a communication audit method as a conventional audit system. FIG. 5 is a conceptual view illustrating an encryption communication system relating to the communication audit method and communication audit method.

In FIG. 5, an internal network 111 is a local area network including an intra-company network (intra-corporate network). For example, terminals installed at the respective departments of the company, factories, sales offices and the like are connected via the network. The internal network 111 may be a network in a predetermined unit of organization or unit of management without being limited to the intra-company network.

An external network 112 is a network, which is provided externally when viewed from the internal network 111. For example, in the case where the internal network is an intra-corporate network, the external network corresponds to an outside-company network. As an example of external network 112, the Internet, which is set up throughout the world, is a typical example.

A communication audit apparatus 120 uses a terminal belongs to the internal network 111 as a target to be managed. Then, the communication audit apparatus 120 supervises information to be sent to the external network 112 from the terminal belonging to the internal network 111. In this example, the communication audit apparatus 120 supervises information in units of packet. Namely, the communication audit apparatus 120 supervises transmission of the packet about which user of the internal network is used as a sender and which user of the external network is used as a receiver based on information about a sender and a receiver written in the packet. Then, the communication audit apparatus 120 collects statistical information and performs an audit on the packet based on statistical information.

FIG. 6 illustrates the structure of TCP/IP packet as an example of packet to be transferred. As illustrated in FIG. 6, the packet includes at least a sender address 121, a receiver address 122, kind of protocol (port number) 123, and data content 124. In this example, data that can specify a user as a sender (internal user) is included in the packet. For example, the internal user can be specified by the sender address 121. The internal user encrypts information (data content 124 in FIG. 6) using secret key cryptogram and performs communication. A secret key used by the internal user is managed in the internal network 111 wherein the user or a pair of the user and the transmission counterpart is used as a key.

An explanation will be next given of the function of communication audit apparatus 120. The communication audit apparatus 120 grasps the situation of transmission of data from the internal user to the external user through statistical processing with reference to the sender address 121 of packet and the receiver address 122. When a predetermined statistical quantity satisfies a predetermined condition (for example, the cumulative quantity of transfer packets reaches more than a threshold value), the communication audit apparatus 120 does not transfer the packet to the original receiver but decode encrypted information in the packet. Then, the communication audit apparatus 120 transfers the packet to an auditor (namely, internal specific user) in order to audit the content.

FIG. 7 illustrates the outline of the audit performed by the communication audit apparatus 120. In FIG. 7, it is assumed that user B is an internal user (for example, employee) and user C and user D are external users (for example, outside-company users).

When receiving a packet addressing to the external user C from the internal user B or addressing to the user D, the communication audit apparatus 120 checks the sender address and receiver address, which are described in the packet, and accumulates the number of packets every pair of sender and receiver.

FIG. 7 illustrates the status in which the packet transfer is performed to C X times, and D Y times as a communication record of user B. Here, for example, it is assumed that the above predetermined condition is set to “when the packet just received is transferred to the destination, the number of communication times exceeds X times (where X>Y). In this case, when the packet is transmitted from user B to user D in the status of FIG. 7, this packet does not satisfy the above condition. For this reason, the communication audit apparatus 120 sends the packet to user D (the number of communication times to D results in Y+1). On the other hand, when the packet is transmitted from user B to user C in the status of FIG. 7, the number of communication times to C is counted up (X+1), so that this packet satisfies the above condition. For this reason, the communication audit apparatus 120 transfers this packet to not user C but the terminal of an auditor A.

The auditor A to which the packet has been thus transferred decodes encrypted data of the packet using the secret key specified by the sender address (or the pair of the sender address and receiver address) to make it possible to audit the content.

Here, the secret key is managed by the terminal of auditor A, or a server directly connected to the terminal, or other server apparatus provided in the internal network 111, and is obtainable at the terminal of auditor A. After auditing, when there is no problem in the content, the packet can be newly sent to the original receiver from the terminal of auditor A. Moreover, an identifier is added to the packet and held in the communication audit apparatus 120, and the terminal of auditor A can instruct the communication audit apparatus 120 to specify the identifier of packet and send it to the original receiver. It is also possible to instruct the sender of packet to send the packet to the original receiver again.

Accordingly, the predetermined condition is appropriately set, making it possible to narrow the audit target and audit efficiently and effectively. For example, the predetermined condition is set to the threshold value of the total number of transfer times, making it possible to use only information, which has the specific pair of sender and receiver whose number of transfer times is extremely high, as a target audit.

Next, an example of the internal structure of the communication audit apparatus 120 will be illustrated by FIG. 8. The communication audit apparatus 120 includes a packet analyzer 143, transmission log obtainer 145, transmission packet statistical processor 146, audit condition determinator 147, and mail transmitter 148. Here, in FIG. 8, a mail from B 141 indicates an encrypted mail from user B, and a packet from B 142 indicates the outline of information included in the packet to be transmitted.

First, when the communication audit apparatus 120 receives mail (encrypted mail) from B 141, the packet analyzer 143 detects a packet sender and receiver described in the packet from B 142. The packet analyzer 143 also detects other information such as the kind of protocol, data quantity, and so on as required.

Next, the transmission log obtainer 145 obtains a log every pair of the sender and receiver of the packet. The content of log is composed of, e.g. data and time, sender, receiver, kind of protocol, and so on. Or, data quantity may be added thereto.

Sequentially, the transmission packet statistical processor 146 performs statistical processing every packet based on information sent from the transmission log obtainer 145. Here, the transmission packet statistical processor 146 counts the number of packets every pair of sender and receiver. The statistical processing may be performed every pair of sender, receiver, kind of protocol, or the number of packets may be counted every pair of sender and receiver according to the specific kind of protocol. Or, statistical processing may be performed by other various kinds of methods. Additionally, the structure having no transmission log obtainer 145 in the communication audit apparatus 120 may be possible. In this case, necessary data is directly given to the transmission packet statistical processor 146 from the packet analyzer 143.

Next, the audit condition determinator 147 determines whether or not a given statistical quantity obtained by statistical processing every packet satisfies a predetermined condition.

Here, as one example, it is assumed that the given statistical quantity is the number of transmission times n. It is also assumed that the predetermined condition is set to “the number of transmission times n is more than threshold value N.” In this case, the audit condition determinator 147 compares the threshold value N for determining whether or not the encrypted mail should be audited with the number of transmission times n.

In the case where the above condition is not met (N>n), the communication audit apparatus 120 sends e-mail to the original receiver, that is, the external network 112 since the condition to be audited is not met.

While, in the ease where the above condition is met (N≦n), the mail transmitter 148 of the communication audit apparatus 120 sends this mail to the auditor A since the condition to be audited is met. Here, in the communication audit apparatus 120, this mail may be stored in a buffer until the packet is transmitted, and it may be relayed through the packet analyzer 143, transmission log obtainer 145, transmission packet statistical processor 146, audit condition determinator 147, and mail transmitter 148.

An explanation will be next given of the operation of communication audit apparatus 120 using the specific example. It is assumed that mail (encrypted mail) from B 141 is transmitted from user B of FIG. 8 to user C. In the encrypted mail sent from user B, a packet has a sender and receiver added as a header as illustrated in the packet from B 142 of FIG. 8.

In the communication audit apparatus 120 that has received this packet, the packet analyzer 143 detects that the packet is one that is sent from user B and that the packet is sent to user C, and transmits the detection result to the transmission log obtainer 145.

The transmission log obtainer 145 records a log of packet transmission in a state that the sender and receiver are pared. In this example, the transmission log obtainer 145 records a log in which the user B has sent the packet to user C.

The communication audit apparatus 120 sends this result to the transmission packet statistical processor 146 by which counts the number of specific packets, for example, the number of packets so far that are transmitted currently. Then, it is assumed that the counted result is n.

The communication audit apparatus 120 sends this result n to the audit condition determinator 147 by which the result n is compared with a certain threshold value N. This threshold value is one that is predetermined the auditor A. At this time, when n is below the threshold value N, the communication audit apparatus 120 sends the packet to user C, that is, external network 112.

On the other hand, when n is more than the threshold value N, the communication audit apparatus 120 sends the encrypted mail transmitted by user B to the auditor A using the mail transmitter 148. Here, at the same time, the communication audit apparatus 120 can send the fact in which the number of packets to user C from user B reaches more than the threshold value N using e-mail.

As a result, the auditor A decodes the encrypted mail directed to user C from user B using a given key, so that the content can be audited. Moreover, the mail transmitter 148 of communication audit apparatus 120 transmits a packet with a specific content, e.g., packet having a unused port number added, to a host machine of user B. The host machine of user B receives this specific packet at an alarm message display 149, so that an alarm message, e.g., “An audit on encrypted mail will be carried out from now on” can be displayed on a display of the machine used by user B. This alarm message can be implemented with respect to each host machine by use of software, similar to an alarm system for firewall, which is currently used.

The above has showed one example in which “the number of packets reaches more than the threshold value” is used as a given statistical quantity and a predetermined condition. However, it is possible to limit the range of sender as an audit target, the range of receiver, or the range of the pair of sender and receiver. Moreover, the given condition and predetermined statistical quantity may be set every sender, receiver, or the pair of sender and receiver.

Furthermore, the predetermined statistical quantity may be obtained every fixed time. For example, the number of transfer packets is cleared at the beginning of the month. Then, it is possible to perform the comparison between the number of transfer packets and the threshold value in the corresponding month, or it is possible to perform the comparison between the number of transfer packets and the threshold value for past fixed time since a given date.

Still furthermore, the above has showed the case in which the packet to be audited is transferred to the auditor. However, only the message may be transferred to the auditor without transferring the packet to the auditor. In this case, the auditor can also audit the packet held in the communication audit apparatus.

Still furthermore, when the internal user starts up the host machine and logs in to the machine, it is possible to display the message, “In the case of encrypting information to transmit encrypted information to the outside by the present system, the content of information is sometimes decoded and audited.” on the screen. This gives the alarm to the user, making it possible to obtain an effect that psychologically suppresses such fraud that leaks information relating to company secret to the outside to prevent such occurrence.

However, the above-explained audit system has no idea in ensuring reliability of the auditor and system itself, and there is left a possibility that a significant record will be leaked. Moreover, the point to be audited is the contact between the external network such as the Internet and the internal network in the company, and it cannot be said that the infrastructural system, which grants extremely high authorization and responsibility to the auditor hierarchically, is established. This results in the audit having only specified collective responsibility rather than all-inclusive audit having social responsibility. Then, in the case where the electronic commerce transaction occupies a large distribution percentage on the total transactions, an extremely dangerous situation will be brought about.

Though the above-mentioned audit system performs the analysis of packet, the audit of only one limited site is performed and the condition is set to one relating to only the site. However, in the actual electronic commerce transaction, there is a message transfer that is more complicated than the mail system, and there is the number of cases in which the message exchange between only two sites is performed is rather small. For this reason, in the actual electronic commerce transaction, it is necessary to grasp the wide network area and perform an audit on the verification of event. Therefore, the aforementioned audit system cannot be implemented by the above-mentioned audit system.

Moreover, the above-mentioned audit system uses items relating to the system structure as main audit targets, and cannot judge the content of message so that the audit cannot be performed. For example, regarding the audit on whether or not financial dishonor occurs, this cannot be implemented unless the content of message is correctly judged in addition to the trace of packet. Accordingly, the aforementioned audit system cannot be used to audit the actual electronic commerce transaction.

In recent years, the electronic commerce transaction plays an important role increasingly, and is occupying the important position in the total transactions. For this reason, there has been needed means, which is capable of auditing the environment of electronic commerce transaction strictly and accurately in real time.

### SUMMARY OF THE INVENTION

The present invention has been made to solve the aforementioned problems, and it is an object of the present invention to provide an electronic commerce transaction audit system that is capable of improving reliability of an auditor and the system itself, electronic commerce transaction audit method, and storage medium having an electronic commerce transaction audit program thereon.

Moreover, it is an object of the present invention to provide an electronic commerce transaction audit system that is capable of grasping a wide network area to perform an audit on verification of an event, electronic commerce transaction audit method, and storage medium having an electronic commerce transaction audit program thereon.

Still moreover, it is an object of the present invention to provide an electronic commerce transaction audit system that is capable of judging the content of message to perform an audit, electronic commerce transaction audit method, and storage medium having an electronic commerce transaction audit program thereon.

Still moreover, it is an object of the present invention to provide an electronic commerce transaction audit system, electronic commerce transaction audit method, and storage medium having an electronic commerce transaction audit program thereon, which are capable of auditing whether or not a computer for exchanging a message of each participating organization including companies is mounted in such a manner that satisfies various kinds of requirements on specifications relevant to the electronic commerce transaction and whether or not there is a problem in the processing ability under the environment of electronic commerce transaction implemented by a computer connected to a network.

In order to attain the above object, according to a first aspect of the present invention, there is provided an electronic commerce transaction audit system comprising a plurality of electronic notarize means, connected to each other via a network, for uniformly stamping time on all exchange messages between electronic commerce transaction entities to record and store the stamped time, and the electronic notarize means vie with each other to take a mutual notarization of the all exchange messages recorded and stored.

The system may further comprise transaction log collect means for automatically collecting all exchange messages notarized and recorded by the plurality of electronic notarize means and for verifying reliability of the all collected exchange messages, whereby determining an event occurred in the entire network area.

Moreover, the system may further comprise log analyze means for comparing the event occurred in the entire network area and verified and determined by the transaction log collect means with an event grasped in advance and to be generated in the entire network area, whereby auditing conformity with specifications on the electronic commerce transaction between the respective electronic commerce transaction entities.

Still moreover, the system may further comprise log analyze means for obtaining time that elapses before a response message is returned after receiving a request message in connection with the event occurred in the entire network area and verified and determined by the transaction log collect means, whereby auditing a respond reaction ability of each electronic commerce transaction entity.

Still moreover, the system may further comprise log analyze means for calculating a frequency of occurrence of an abnormal response in connection with the event occurred in the entire network area and verified and determined by the transaction log collect means, whereby auditing an abnormal response processing ratio of each electronic commerce transaction entity.

Still moreover, the system may further comprise cumulative estimation control means for recording the audit result obtained by the log analyze means to be associated with an identifier of each electronic commerce transaction entity; and audit information service means, when there is a provision request for audit information that has specified the identifier of electronic commerce transaction entity, for extracting the audit result recorded to be associated with the corresponding identifier from the cumulative estimation control means so as to provide the extracted audit result as audit information.

According to a second aspect of the present invention, there is provided an electronic notarizing apparatus comprising transaction log storage means for uniformly stamping time on all exchange messages between electronic commerce transaction entities to record and store the stamped time; notarize means for requesting other electronic notarizing apparatus to notarize all exchange messages recorded and stored by the transaction log storage means and for receiving a response to the corresponding request from the other electronic notarizing apparatus; and transaction certification storage means for storing the response received by the notarize means.

According to a third aspect of the present invention, there is provided an electronic commerce transaction audit apparatus comprising log analyze means for comparing an event occurred in the entire network area and with an event grasped in advance and to be generated in the entire network area, whereby auditing conformity with specifications on the electronic commerce transaction between the respective electronic commerce transaction entities.

According to a fourth aspect of the present invention, there is provided an electronic commerce transaction audit apparatus comprising log analyze means for obtaining time that elapses before a response message is returned after receiving a request message in connection with an event occurred in the entire network area, whereby auditing a respond reaction ability of each electronic commerce transaction entity.

According to a fifth aspect of the present invention, there is provided an electronic commerce transaction audit apparatus comprising log analyze means for calculating a frequency of occurrence of an abnormal response in connection with an event occurred in the entire network area, whereby auditing an abnormal response processing ratio of each electronic commerce transaction entity.

According to a sixth aspect of the present invention, there is provided an electronic commerce transaction auditing method wherein a plurality of electronic notarize means, which uniformly stamp time on all exchange messages between electronic commerce transaction entities to record and store the stamped time, vie with each other to take a mutual notarization of the all exchange messages recorded and stored via a network.

The estimation means, which is provided independently of the plurality of electronic notarize means, may automatically collect all exchange messages recorded and stored by the plurality of electronic notarize means and verify reliability of the all collected exchange messages, whereby determining an event occurred in the entire network area.

Moreover, the estimation means may further compare the event occurred in the entire network area and verified and determined with an event grasped in advance and to be generated in the entire network area, whereby auditing conformity with specifications on the electronic commerce transaction between the respective electronic commerce transaction entities.

Still moreover, the estimation means may further obtain time that elapses before a response message is returned after receiving a request message in connection with the event occurred in the entire network area and verified and determined, whereby auditing a respond reaction ability of each electronic commerce transaction entity.

Still moreover, the estimation means may further calculate a frequency of occurrence of an abnormal response in connection with the event occurred in the entire network area and verified and determined, whereby auditing an abnormal response processing ratio of each electronic commerce transaction entity.

Still moreover, the estimation means may further record the audit result to be associated with an identifier of each electronic commerce transaction entity, and extract the audit result recorded to be associated with the corresponding identifier to provide the extracted audit result as audit information when there is a provision request for audit information that has specified the identifier of electronic commerce transaction entity.

According to a seventh aspect of the present invention, there is provided an electronic commerce transaction auditing method comprising the first step of uniformly stamping time on all exchange messages between electronic commerce transaction entities to record and store the stamped time; the second step of requesting other electronic notarizing apparatus to notarize all exchange messages recorded and stored in the first step; the third step of receiving a response to the corresponding request in the second step; and the fourth step of storing the response received in the third step.

According to an eighth aspect of the present invention, there is provided an electronic commerce transaction audit method wherein an event occurred in the entire network area is compared with an event grasped in advance and to be generated in the entire network area, whereby auditing conformity with specifications on the electronic commerce transaction between the respective electronic commerce transaction entities.

According to a ninth aspect of the present invention, there is provided an electronic commerce transaction audit method wherein time that elapses before a response message is returned after receiving a request message is obtained in connection with an event occurred in the entire network area, whereby auditing a respond reaction ability of each electronic commerce transaction entity.

According to a tenth aspect of the present invention, there is provided an electronic commerce transaction audit method wherein a frequency of occurrence of an abnormal response is calculated in connection with an event occurred in the entire network area, whereby auditing an abnormal response processing ratio of each electronic commerce transaction entity.

According to an eleventh aspect of the present invention, there is provided a storage medium having a computer-program recorded thereon, the storage medium causing a computer to execute the first processing of uniformly stamping time on all exchange messages between electronic commerce transaction entities to record and store the stamped time; the second processing of requesting other electronic notarizing apparatus to notarize all exchange messages recorded and stored in the first step; the third processing of receiving a response to the corresponding request in the second step; and the fourth processing of storing the response received in the third step.

According to a twelfth aspect of the present invention, there is provided a storage medium having a computer-program recorded thereon, the storage medium causing a computer to execute processing of comparing an event occurred in the entire network area with an event grasped in advance and to be generated in the entire network area, whereby auditing conformity with specifications on the electronic commerce transaction between the respective electronic commerce transaction entities.

According to a thirteenth aspect of the present invention, there is provided a storage medium having a computer-program recorded thereon, the storage medium causing a computer to execute processing of obtaining time that elapses before a response message is returned after receiving a request message in connection with an event occurred in the entire network area, whereby auditing a respond reaction ability of each electronic commerce transaction entity.

According to a fourteenth aspect of the present invention, there is provided a storage medium having a computer-program recorded thereon, the storage medium causing a computer to execute processing of calculating a frequency of occurrence of an abnormal response in connection with an event occurred in the entire network area, whereby auditing an abnormal response processing ratio of each electronic commerce transaction entity.

According to a fifteenth aspect of the present invention, there is provided a storage medium group wherein the program recorded on the storage medium according to eleventh to fifteenth is divided into a plurality of portions and the plurality of portions is recorded on each of a plurality of storage mediums.

### BRIEF DESCRIPTION OF THE DRAWINGS

These objects and other objects and advantages of the present invention will become more apparent upon reading of the following detailed description and the accompanying drawings in which:

FIG. 1 is a block diagram illustrating the structure of an electronic commerce transaction system of the first embodiment of the present invention;

FIG. 2 is a view relating to a directed graph model having the array that is generated on memory from Trace Structure with the same Transaction Identifier;

FIG. 3 is a flowchart illustrating the audit procedure according to a first embodiment of the present invention;

FIG. 4 is a block diagram illustrating the structure of the electronic commerce transaction audit system of a second embodiment of the present invention;

FIG. 5 is a conceptual view illustrating an encryption communication system relating to the conventional communication audit method and communication audit method;

FIG. 6 is a view illustrating the structure of TCP/IP packet as an example of a conventional packet as a transfer target;

FIG. 7 is a view illustrating the outline of audit performed by the conventional communication audit apparatus; and

FIG. 8 is a view illustrating one example of the internal structure of the conventional communication audit apparatus.

### DETAILED DESCRIPTION OF THE PREFERRED EMBODIMENTS

Embodiments of the present invention will be specifically explained with reference to the drawings accompanying herewith.

### First Embodiment

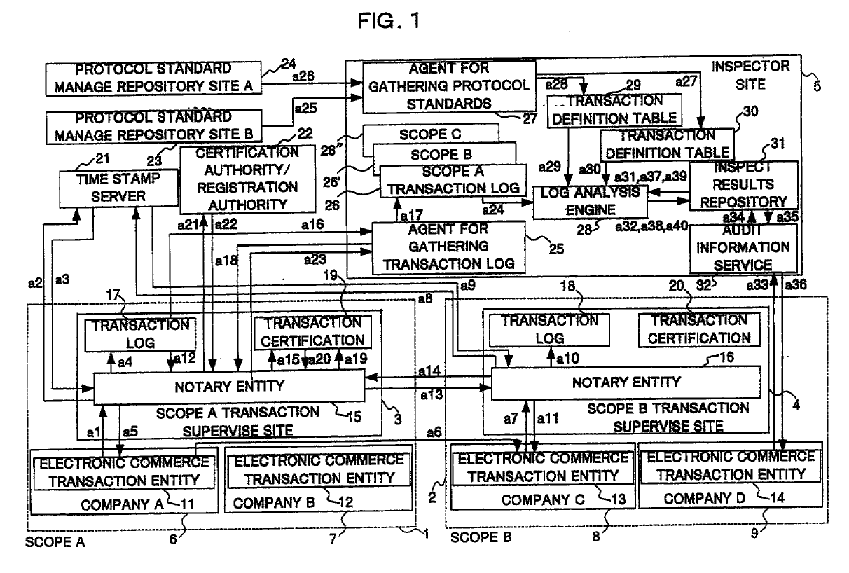

FIG. 1 is a block diagram illustrating the structure of an electronic commerce transaction system of the first embodiment of the present invention. As illustrated in FIG. 1, the electronic commerce transaction system according to this embodiment includes scope transaction supervise sites 3 and 4, which supervise the scopes to which company groups, which carry out electronic commerce belong, inspector site 5, time stamp server 21, and certification authority/registration authority 22.

In the present embodiment, as illustrated in FIG. 1, company A 6 and company B 7 belong to scope A 1, and company C 8 and company D 9 belong to scope B 2. In scope A 1, names of participating companies, access destinations, service to be supported, and the like are specifically managed by the scope A transaction supervise site 3 in scope A 1 and the scope B transaction supervise site 4 in scope B 2, respectively.

In company A 6, an electronic commerce transaction entity 11 is included. Similarly, an electronic commerce transaction entity 12, electronic commerce transaction entity 13, and electronic commerce transaction entity 14 are included in company B 7, company C 8, and company D 9, respectively. These electronic commerce transaction entities 11, 12, 13, and 14 manage communication statuses of various kinds of messages on electronic commerce.

The scope A transaction supervise site 3 includes a notary entity 15, transaction log 17, and transaction certification 19. The notary entity 15 traces a message relating to electronic commerce transaction that is carried out among the electronic commerce transaction entities 11, 12, 13, and 14, and manages the communication status. The transaction log 17 manages all histories of the transaction that is implemented by the message relating to electronic commerce transaction that is carried out among the electronic commerce transaction entities 11, 12, 13, and 14. The transaction certification 19 insures the validity of the transaction log 17.

Similarly, the scope B transaction supervise site 4 includes a notary entity 16, transaction log 18, and transaction certification 20 that insures the validity of transaction log 18.

The inspector site 5 includes a agent for gathering transaction log 25 that collects transaction logs 17 and 18, agent for gathering protocol standards 27, transaction logs 26, 26′, 26″ that are generated by duplicating the transaction logs 17 and 18, log analysis engine 28 that analyzes transaction logs 26, 26′, 26″ to audit the electronic commerce transaction entities 11, 12, 13, and 14 that the respective companies possess, inspect results repository 31 that controls an audit result produced by the log analysis engine 28, transaction definition table 30 to which the log analysis engine 28 refers at the auditing time, transaction definition table 29, and audit information service 32 that provides audit information service to each company using the above inspect results repository 31 that controls the audit result.

An explanation will be next given of the specific processing procedure of electronic commerce transaction system according to the present embodiment.

First, an explanation will be given of the supervision operations, which are carried out by the scope A transaction supervise site 3 and scope B transaction supervise site 4 when the company A 6 belonging to the scope A 1 conducts electronic commerce transaction with the company C 8 belonging to the scope B 2.

In this case, the electronic commerce transaction entity 11, which manages communication status of various kinds of messages on electronic commerce transaction, transfers a time stamp request al to the notary entity 15 provided in the scope A transaction supervise site 3 that first manages the scope A 1.

The time stamp request al has the following structural components:

Time Stamp Request::={
Digest Of Message;
Entity Identifier Of Sender;
Entity Identifier Of Receiver;
Category Of Message;
Identifier Of Message;
Transaction Identifier;
Invocation Time At Sender;
Signature Of Sender;
Key Information;
};

Here, “Digest Of Message” in the time stamp request al is a resultant value obtained by digest-calculating a request message a6, which a company A 6 will transfer to a company C 8, according to a designated form.

“Entity Identifier Of Sender” and “Entity Identifier Of Receiver” in the time stamp request al mean access points relating to the electronic commerce transaction entity 11 and electronic commerce transaction entity 13, and they are described by URI (Uniform Resource Identifier) which is fixed by the World Wide Web Consortium (W3C).

“Category Of Message” and “Identifier Of Message” in the time stamp request al specify a kind of message to be sent. The present system is not intended for only the specific consortium typically such as RosettaNet. Thus, in connection with “Category Of Message”, an identifier of consortium that defines a message to be sent is set, and in connection with “Identifier Of Message”, a message identifier of the consortium is set. For example, in the case where the present system is intended for RosettaNet, a character string such as “RosettaNet” is set in “Category Of Message” and a character string, which combines a PIP number that specifies a kind of message with the kind of message, is set in “Identifier Of Message.”

“Transaction Identifier” and “Invocation Time At Sender” in the time stamp request a1 mean an identifier, which specifies a transaction that is implemented by the message, and a local startup time in the electronic commerce transaction entity 11, respectively. “Transaction Identifier” is set to have a unique value through the entirety of system, and the same value is maintained and used until the transaction completes the operation, which is based on the specifications after carrying out the operation. This is equivalent to identification information in which a serial number that is managed in the site is added to an identifier of the transaction supervise site. The log analysis engine 28 determines compliance with the specifications on the transaction that is implemented by exchanging a plurality of messages based on the “Transaction Identifier.”

“Signature Of Sender” in the time stamp request al means that a signature is placed on “Digest of Message” using a private key of the electronic commerce transaction entity 11. In contrast to this, “Key Information” in the time stamp request al is information relating to a public key certification corresponding to the private key.

When receiving time request a1, the notary entity 15 transfers a time request a2 to the time stamp server 21 such that time stamping can be made at correct time in the system.

After receiving time request a2, the time stamp server 21 transfers a time value response a3 to the notary entity 15 in an appropriate expression form.

After receiving time value response a3, the notary entity 15 generates a reception confirmation a4 structured as set forth below in combination with the time stamp request a1, and stores it to the transaction log 17 as maintaining a time sequence. The reception confirmation a4 has a following structural component.

Receive Confirmation::={
Time Stamp Request;
Time Stamp Value;
Signature Of Notary Entity;
Key Information;
};

“Time Stamp Request” in the reception confirmation a4 is equivalent to the time stamp request a1. “Time Stamp Value” is equivalent to the value of time value response a3.

“Signature Of Notary Entity” in the reception confirmation a4 means that the above-mentioned “Time Stamp Request” and “Time Stamp Value” are combined and a signature is placed thereon using a private key of the notary entity 15. In contrast to this, “Key Information” in the reception confirmation a4 is information relating to a public key certification corresponding to the private key of notary entity 15.

Thereafter, the notary entity 15 returns a time stamp response a5, which has the same structural components as the reception confirmation a4 and corresponds to the time stamp request a1, to the electronic commerce transaction entity 11.

The time stamp response a5 has the following structural components:

Time Stamp Response::={
Time Stamp Request;
Time Stamp Value;
Signature Of Notary Entity;
Key Information;
};

The electronic commerce transaction entity 11 that has received the time stamp response a5 sends a request message a6 to be transferred to the electronic commerce transaction entity 13 in the company C 8 as a transfer destination, In this case, “transaction Identifier”, which is a transaction specific identifier, is included in the request message a6. At this time, the time stamp response a5 does not particularly have to be transferred.

When receiving the request message a6, the electronic commerce transaction entity 13 in the company C 8 transfers a time stamp request a7 to the notary entity 16 in the scope B transaction supervise site 4 that manages the scope B 2.

The time stamp request a7 has the same structural components as the time stamp request al, and takes the following structural components:

Time Stamp Request::={
Digest Of Message;
Entity Identifier Of Sender;
Entity Identifier Of Receiver;
Category Of Message;
Identifier Of Message;
Transaction Identifier;
Invocation Time At Sender;
Signature Of Sender;
Key Information;
};

“Digest of Message” in the time stamp request a7 is a resultant value obtained by digest-calculating the request message, which the company A 6 has transferred to the company C 8, according to a designated form.

“Transaction Identifier” in the time stamp request a7 means an identifier, which specifies a transaction that is implemented by the request message a6. Since “Transaction Identifier” is set to have a unique value through the entirety of system, this has the same value as “Transaction Identifier” in the time stamp request a1.

“Invocation Time At Sender” in the time stamp request a7 means a local startup time in the electronic commerce transaction entity 13.

“Signature Of Sender” in the time stamp request a7 means that a signature is placed on the aforementioned “Digest of Message” using a private key of the electronic commerce transaction entity 13. Accordingly, this becomes a different value from the value of “Signature Of Sender” in the time stamp request al. Moreover, “Key Information” in the time stamp request a7 is information relating to a public key certification corresponding to the private key. This also becomes a different value from the value of “Key Information” in the time stamp request a1.

When receiving time request a7, the notary entity 16 transfers a time request a8 to the time stamp server 21 such that time stamping can be made at correct time in the system.

After receiving time request a8, the time stamp server 21 transfers a time value response a9 to the notary entity 16 in an appropriate expression form.

After receiving time value response a9, the notary entity 16 generates a receive confirmation a10, which has the same structural components as the reception confirmation a4, in combination with the time stamp request a7, and stores it to the transaction log 18 as maintaining a time sequence.

“Time Stamp Request” in the reception confirmation a10 is equivalent to the time stamp request a7. “Time Stamp Value” is equivalent to the value of time value response a9.

Thereafter, the notary entity 16 returns a time stamp response a11, which has the same structural components as the reception confirmation a4 and which corresponds to the time stamp request a7, to the electronic commerce transaction entity 13.

After that, the electronic commerce transaction entity 13 carries out requested processing to send a request message occurred in a chain reaction manner to the electronic commerce transaction entity of the other company or return a response message corresponding to the request message a6 to the electronic commerce transaction entity 11. Regarding what response message the electronic commerce transaction entity 13 should be transferred; it is fixed by a protocol standard that is managed by a protocol standard manage repository site A 24 and a protocol standard manage repository site B 23.

The notary entity 15 stores the reception confirmation a4 to the transaction log 17 as maintaining the time sequence. In addition, the notary entity 16 also stores the reception confirmation a10 to the transaction log 18 as maintaining the time sequence.

By the way, since it is necessary for notary entities 15 and 16 to ensure consistency on notary processing, they vie with each other to take a mutual notarization of transaction log every time interval Δ, which is predetermined among a plurality of notary entities including notary entities 15 and 16.

For example, the notary entity 15 extracts all reception confirmations a4, including the oldest reception confirmation a4 after previous final time T up to reception confirmation a4 at time (T+Δ), from the transaction log 17 every time interval Δ, and generates a transaction list a12 including them.

Transaction List::={
Receive Confirmation [0];
................
Receive Confirmation [N];
};

Thereafter, the notary entity 15 updates final time T managed on memory to time (T+Δ). The array of components of each “Receive Confirmation” corresponds to the receive confirmation a4.

After that, the notary entity 15 generates a transaction certification request a13 based on the transaction list 12a. The transaction certification request a13 takes the following structural components:

Transaction Notary Request::={
Transaction List;
Entity Identifier Of Sender;
Entity Identifier Of Receiver;
Invocation Time At Sender;
Signature Of Sender;
Key Information;
};

“Entity Identifier Of Sender” in the transaction certification request a13 means an access point relating to the notary entity 15 and it is described by URI (Uniform Resource Identifier) which is fixed by the World Wide Web Consortium (W3C). Also, “Entity Identifier Of Receiver” in the transaction certification request a13 means an access point relating to one of the plurality of other notary entities vying with the notary entity 15 to take a mutual notarization, and it is also described by URI (Uniform Resource Identifier) which is fixed by the World Wide Web Consortium (W3C).

“Invocation Time At Sender” in the transaction certification request a13 means a local startup time in the notary entity 15.

“Signature Of Sender” in the transaction certification request a13 means that “Transaction List” is digest-calculated according to the determined form and a signature is placed thereon using the private key of the notary entity 15. In contrast to this, “Key Information” in the transaction certification request a13 is information relating to a public key certification corresponding to the private key.

Here, it is assumed that one of the plurality of other notary entities vying with the notary entity 15 to take a mutual notarization is the notary entity 16 in the scope B2. When receiving the transaction certification request a13 from the notary entity 15, the notary entity 16 places a signature thereon, and returns a transaction certification response a14 to the notary entity 15. The transaction certification response a14 takes the following structural components:

Transaction Notary Response::={
Transaction Notary Request;
Entity Identifier Of Sender;
Entity Identifier Of Receiver;
Invocation Time At Sender;
Signature Of Sender;
Key Information;
};

“Entity Identifier Of Receiver” in the transaction certification response a 14 means an access point relating to the notary entity 15 and it is described by URI (Uniform Resource Identifier) which is fixed by the World Wide Web Consortium (W3C). Also, “Entity Identifier Of sender” in the transaction certification request a13 means an access point relating to one of the plurality of other notary entities vying with the notary entity 15 to take a mutual notarization, and it is also described by URI (Uniform Resource Identifier) which is fixed by the World Wide Web Consortium (W3C).

“Invocation Time At Sender” in the transaction certification response a14 means a local startup time in the notary entity 16.

“Signature Of Sender” in the transaction certification response a14 means that the structure of transaction certification request 13a, that is, “Transaction Notary Request” itself is digest-calculated according to the determined form and a signature is placed thereon using the private key of the notary entity 16. In contrast to this, “Key Information” in the transaction certification response a14 is information relating to a public key certification corresponding to the private key.

When receiving the transaction certification response a14, the notary entity 15 analyzes the content and extracts necessary information items, and transfers a registration request a15 to the transaction certification 19. The registration request a15 takes the following structural components:

Transaction Notary Update::={
Transaction Notary Response;
Entity Identifier Of Sender;
Entity Identifier Of Receiver;
Invocation Time At Sender;
Signature Of Sender;
Key Information;
};

The registration request a15 is substantially equivalent to the transaction certification response a14.

Moreover, the electronic commerce transaction audit system of the present embodiment includes the inspector site 5. The inspector site 5 performs an automatic collection of transaction logs from the scope A transaction supervise 3 and scope B transaction supervise 4 and an audit based on the corresponding transaction log.

Then, an explanation will be next given of the operation to which the inspector site 5 relates.

The inspector site 5 includes the agent for gathering transaction log 25 that gains access to the transaction log in each scope transaction supervise site periodically. In the present embodiment, the agent for gathering transaction log 25 gains access to the transaction log 17 and extracts a transaction log difference a16 corresponding to the difference between the previous collection and the current collection, that is, a transaction log between time T and time (T+Δ). The transaction log difference a16 is synchronized with the transaction list a12, which is generated every time interval Δ, and they are equivalent to each other. The transaction log difference a16 takes the following structural components:

Transaction Log List::={
Receive Confirmation [0];
.......................
Receive Confirmation [N];
};

The array of components of each “Receive Confirmation” corresponds to the receive confirmation a4.

When receiving the transaction log difference a16, the agent for gathering transaction log 25 performs digest calculation of “Transaction Log List” by a determined method to obtain the validity of the content, and transfers the result as a verification request a18 to the notary entity 15. The verification request a18 takes the following structural components:

Transaction Verification Request::={
Digest Of Transaction Log List;
Signature Of Sender;
Key Information;
};

“Digest Of Transaction Log List” in the verification request a18 is the resultant value of the digest calculation. “Signature Of Sender” is that a signature is placed on the resultant value of the digest calculation using a private key of the agent for gathering transaction log 25. In contrast to this, “Key Information” in the verification request a18 is information relating to a public key certification corresponding to the private key.

When receiving the verification request a18, the notary entity 15 verifies the signature value described in “Signature Of Sender” in its interior to confirm that the sender is the agent for gathering transaction log 25. Next, the notary entity 15 extracts “Digest Of Transaction Log List”, which is the resultant value of digest calculation in the verification request a18.

Sequentially, the notary entity 15 issues a reference request a19 to draw the corresponding registration information from transaction certification 19. The transaction certification 19 returns a reference response a20 to the notary entity 15 according to the form, which is equivalent to the registration request a15. More specifically, since the transaction list a12 and transaction log difference a16 are synchronized with each other, the transaction certification 19 can return information at the corresponding time interval as a reference response a20. The reference response a20 takes the following structural components:

Transaction Notary Reference::={
Transaction Notary Response;
Entity Identifier Of Sender;
Entity Identifier Of Receiver;
Invocation Time At Sender;
Signature Of Sender;
Key Information;
};

The notary entity 15 extracts “Signature Of Sender”, which is the signature of other notary entity such as typically notary entity 16, and “Key Information”, which is public key certification information corresponding to the private key.

The form of “Key Information”, which is public key certification information, is not specified, and there is a case in which a certification with X. 509V3 form including the public key itself is described and there is another case in which the access point where the certification is obtainable is described in the form of URI (Uniform Resource Identifier). In the latter case, the notary entity 15 issues a certification obtain request a21 to the certification authority/registration authority 22 and obtains a certification a22 with X. 509V3 form including the public key itself.

Thereafter, the notary entity 15 decodes the extracted “Signature Of Sender” using the public key added to the obtained certification and obtains a digest value described on the transaction certification 19. After that, the notary entity 15 compares the corresponding digest value with “Digest Of Transaction Log List”, which is the resultant value of the digest calculation in the verification request a18. Since the notary entity 15 exchanges the mutual notarization with the plurality of other notary entities, the notary entity 15 provides comparison processing of the corresponding digest value to all reference responses a20 stored in the transaction certification 19.

When it is confirmed that no difference is recognized in the comparison between the digest value and any one of reference responses a20, the notary entity 15 returns a verification response a23 to the agent for gathering transaction log 25. The verification response a23 takes the following structural components:

Transaction Verification Request::={
Boolean Verified;
};

Here, in the case where no problem is found in “Boolean Verified”, “True” is returned, and “Failure” is returned in the other cases.

When receiving the verification response a23 and confirms “True” in “Boolean Verified”, the agent for gathering transaction log 25 calls a request command a17 for adding/generating an entry to the scope A transaction log 26 that is managed in the inspector site 5.

The scope A transaction log 26 includes not only the transaction log difference a16 but also all receive confirmations a4, which are within a fixed valid time.

The agent for gathering transaction log 25 extracts transaction logs from all scope transaction supervise sites in the same way, and generates scope B transaction log 26′ and transaction log” similar to the scope A transaction log 26.

The inspector site 5 also includes the agent for gathering protocol standards 27. The agent for gathering protocol standards 27 extracts latest protocol descriptions a25 and a26 from the plurality of protocol standard manage repository sites 23 and 24 that manage the protocol standard periodically. The protocol standard manage repository site A 23 corresponds to the repository of RosettaNet and a latest protocol description a25 corresponds to PIP definition. Latest information of protocol description, which is expressed in a document form such as PIP definition, is processed by edition/maintenance through a person since the agent for gathering protocol standards 27 has a console.

The agent for gathering protocol standards 27 issues protocol description latest information generation commands a27 and a28 using latest protocol descriptions a25 and a26 as arguments, thus constructing a table relating to a transaction definition table 30 and transaction definition table 29 in the inspector site 5. The transaction definition table 30, and transaction definition table 29 are a definition table of an automaton having the following structural components and a message structure table group, respectively.

Transaction Definition Table::={
Category Of Message;
Current Status Definition;
Input Event Category; (Message Sending, Other Event)
SubCategory Of Message; (Input)
Message Definition; (Input)
Next Status Definition;
Output Event Category; (Message Sending, Other Event)
SubCategory Of Message; (Output)
Message Definition; (Output)
};
Message Table::={
Definition Of Structure in BNF;
};

“Category Of Message” in “Transaction Definition Table” means the kind of message to be exchanged, and this corresponds to, for example, RosettaNet. “Current Status Definition” and “Next Status Definition” in “Transaction Definition Table” mean statuses that the electronic commerce transaction entities 11, 12, 13 and 14 can obtain during the procedure of communication of various kinds of messages in view of software. Specifically, “Current Status Definition” indicates the status before transition and “Next Status Definition” indicates the status after transition.

“Input Event Category” and “Output Event Category” in “Transaction Definition Table” mean all events that the electronic commerce transaction entities 11, 12, 13 and 14 can accept during the procedure of communication of various kinds of messages. Specifically, “Input Event Category” defines an event that may give rise to a status transition and “Output Event Category” defines an event that results from the status transition.

“SubCategory Of Message” and “Message Definition” in “Transaction Definition Table” define the specific kind of message and the construction, respectively.

“Message Table” is one that expresses the description for defining “Message Definition” in BNF (Backus-Naur Form).

Normally, the various kinds of transaction definitions including transaction definition table 30 and transaction definition table 29 are expanded to a huge memory space under control of the log analysis engine 28 in the inspector site 5, and “Transaction Definition Table” reference and “Message Table” references a29 and a30 refer to them.

The log analysis engine 28 is started/driven all the time to perform a status simulation of each of electronic commerce transaction entities 11, 12, 13, and 14.

The log analysis engine 28 refers to transaction definition table 30 and transaction definition table 29 and reads definition information relating to “Category Of Message”, “Current Status Definition”, “Input Event Category”, “SubCategory Of Message”, “Message Definition”, “Next Status Definition”, “Output Event Category”, which are components of “Transaction Definition Table” and “Definition Of Structure in BNF”, which is the component of “Message Table.”

Thereafter, the log analysis engine 28 combines the transaction logs 26, 26′ and 26″ and constructs the following data structure of “Transaction Group Table” in the huge memory space under control of the log analysis engine 28, and “Transaction Group Table” reference a24 refers to this.

Transaction Group Table::={
Transaction Identifier;
List of Trace Structure;
Status: (Compete, Still In Progress)
};
Trace Structure::={
Entity Identifier Of Sender;
Entity Identifier Of Receiver;
Category Of Message;
Identifier Of Message;
Time Stamp Value;
};

The data structure, “Transaction Group Table” is composed of “Transaction Identifier” using as a main key, one that bundles individual message transfers as “Transaction Group Table”, “Trace Structure” that means the specific contents of massage transfers, and “Status” that means the statuses of the series of transactions.

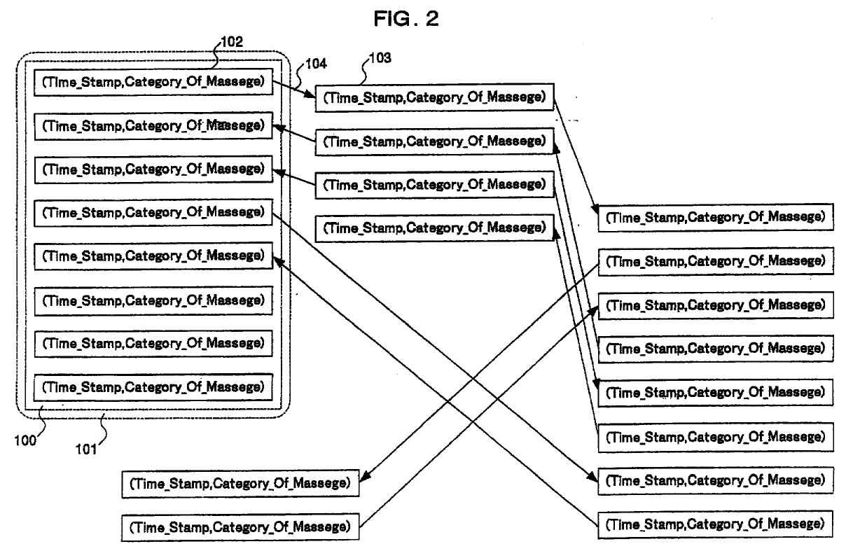

Thereafter, the log analysis engine 28 generates a directed graph model with the array as illustrated in FIG. 2 on memory from “Trace Structure” having the same “Transaction Identifier.” At the time of selecting “Transaction Identifier”, one that has only “Status” with a value of “Still In Progress” is selected. The directed graph model with this array can be defined by the following expressions (1), (2), (3), and (4):
(eₙ(tᵥ), eₘ(tᵤ),D)∈Set of Message (1)
eₙ(tᵥ), eₘ(T_{U})∈Set of Identifier
(∀ₙ, ∃ₘ && n≠m && n, m<∞) at tᵥ, tᵤ (2)
tᵥ, tᵤ∈Set of Time Stamp
(∀v, ∃u && {( v<u when D=“→”)||( v>u when other)} (3)
D∈≡{“→”, “←”} (4)

A node 101 on the graph including the array 100 of FIG. 2 corresponds to any one of electronic commerce transaction entities. The electronic commerce transaction entity is specified by “Entity Identifier Of Sender” of “Trace Structure” or “Entity Identifier” of “Entity Identifier Of Receiver.” Each of members 102 and 103 of the array indicates “Time Stamp”, which is time at which transfer of each message is transmitted/received. An arc 104 between the members 102 and 103 means a message transfer direction.

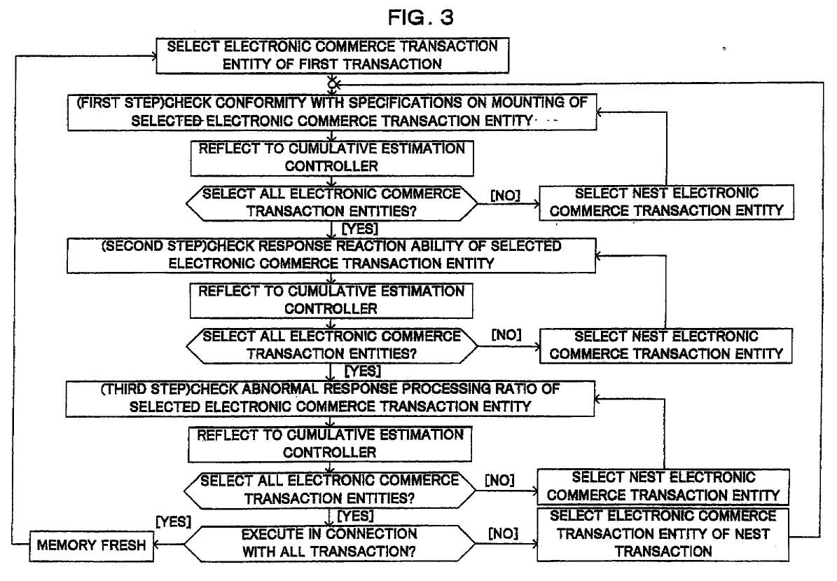

The audit analysis at the log analysis engine 28 is carried out according to the procedure of FIG. 3.

As a first step, attention is focused on one of electronic commerce transaction entities to audit compliance with the specifications on mounting. For this end, attention is paid on, for example, the node 101 of the directed graph of FIG. 2 to extract the corresponding array 100. Then, regarding each member of the array 100, a trial is made to specify the corresponding “Current Status Definition” and “Next Status Definition”, which is a next status, using “Transaction Definition Table” reference, “Message Table” references a29, a30 based on the direction of the arc with a string, initial status, and the kind thereof.

If the above is described by expressions, this corresponds to the fact in which ordered sets, which are given by the following expressions (5), (6), (7), and (8), are specified every electronic commerce transaction entity.
(Status (eₙ(t₁)), Status (eₙ(t₂)), . . . Status (eₙ(tₓ))) (5)
Status (eₙ(tₓ))∈Set of Status at eₙ(tₓ) (∀n, n<∞) at tₓ (6)
eₙ(tₓ)∈Set of Entity Identifier (∀n, n<∞) at tₓ (7)
tₓ∈Set of Time Stamp (0<x<∞) (8)

In the case where the ordered set expressed by expression (5) can be led to the stage of disappearance of “Transaction Identifier”, it is proved that no problem is found in terms of mounting insofar as the verified transaction is concerned.

After that, the log analysis engine 28 designates the identifier of electronic commerce transaction entity with respect to the inspect results repository 31 to extract an audit result record a31 of electronic commerce transaction entity up to the current time. Then, a certification result this time is reflected using a fixed algorithm and is returned to the inspect results repository 31 as a latest audit result record a32.

The log analysis engine 28 performs the aforementioned audio with respect to the corresponding nodes of all electronic commerce transaction entities, and the first step is completed.

As a second step, attention is focused on one of electronic commerce transaction entities and the log analysis engine 28 audits the response reaction ability. Particularly, in the case of dealing with finance-related information, the log analysis engine 28 also audits dishonor possibility verification. For this end, the array of node 101, which is present in the directed graph of FIG. 2, is extracted to calculate a series of Δt that satisfies the condition shown by expression (9) set forth below, thus generating an ordered set.
Δt=tₓ−t_{y}
(tₓ: (eₙ(tₓ), eₘ(tᵤ), “←”)∈Set of Message &&
t_{y}: (eₙ(t_{y}), eₘ(tᵤ), “→”)∈Set of Message) (9)

Δt is time that elapses before a certain electronic commerce transaction entity returns a response message after receiving a request message, and serves as a guideline for describing processing ability of the electronic commerce transaction entity. Particularly, in the case where these messages deal with finance-related information, the kind of message is specified, making it possible to estimate the presence or absence of dishonor possibility.

After that, the log analysis engine 28 designates the identifier of electronic commerce transaction entity with respect to the inspect results repository 31 to extract response reaction/dishonor possibility records a37 of electronic commerce transaction entity up to the current time. Then, an audit result this time is reflected using a fixed algorithm and is returned to the inspect results repository 31 as a latest response reaction/dishonor possibility record a38.

The log analysis engine 28 performs the aforementioned audio with respect to the corresponding nodes of all electronic commerce transaction entities, and the second step is completed.

As a third step, attention is focused on one of electronic commerce transaction entities and the log analysis engine 28 audits an abnormality response processing ratio that the electronic commerce transaction entity issues. For this end, the array of node 101, which is present in the directed graph of FIG. 2, is extracted to calculate a frequency that satisfies the condition shown by expression (10) set forth below.
If (Req(eₙ(tₓ), eₘ(tᵤ), “←”) && Err(eₙ(t_{y}), eₘ(tᵤ), “→”)) {True;}
else if (Req(eₙ(tₓ), eₘ(tᵤ), “←”) && Res(eₙ(t_{y}), eₘ(tᵤ), “→”)) {Failure;}
else {Failure;} (10)

In the case where the category of Definition of Function Req:
∀m: m=(eₙ(tₓ), eₘ(tᵤ), “←”)∈Set of Message is “Request”, Req(m)=True; (11)

In the case where the category of Definition of Function Res:
∀m: m=(eₙ(tₓ), eₘ(tᵤ), “→”)∈Set of Message is “Normal Response”, Res(m)=True; (12)

In the case where the category of Definition of Function Err:
∀m: m=(eₙ(tₓ), eₘ(tᵤ), “→”)∈Set of Message is “Abnormal Response”, Err(m)=True; (13)

Expressions (11), (12), and (13) are functional definitions. In expression (11), if the kind of message to be dealt with corresponds to “request”, “true” is established. In expression (12), if the kind of message to be dealt with corresponds to “normal response”, “true” is established. In expression (13), if the kind of message to be dealt with corresponds to “abnormal response”, “true” is established.

The meaning of expression (10) is a conditional definition for calculating frequency that generates the abnormal response. In the case of high frequency, it is estimated that the electronic commerce transaction entity has a problem in terms of the application system to be connected. This frequency is traced for a long time to make it possible to clarify the problem.

After that, the log analysis engine 28 designates the identifier of electronic commerce transaction entity with respect to the inspect results repository 31 to extract an abnormal response processing ratio audit records a39 of electronic commerce transaction entity up to the current time. Then, an audit result this time is reflected using a fixed algorithm and is returned to the inspect results repository 31 as a latest abnormal response processing ratio audit record a40.

The log analysis engine 28 performs the aforementioned audio with respect to the corresponding nodes of all electronic commerce transaction entities, and the third step is completed.

After carrying out the first, second, and third steps, the log analysis engine 28 erases the directed graph model from the memory, and rewrites “Status” of “Transaction Identifier” of “Transaction Group Table” obtained from “Transaction Group Table” reference a24 to “Complete.” After that, the log analysis engine 28 regenerates the similar directed graph model on the memory from “Trace Structure” in which “Status” has a value of “Still In Progress” and which corresponds to “Transaction Identifier.” In the case where no appropriate “Transaction Identifier” can be extracted, the “Transaction Group Table” reference a24 is refreshed and processing goes to a next processing round.

In the case where the electronic commerce transaction entity 14 mounted on the company D9 of FIG. 1 performs message communication with other electronic commerce transaction entity according to the start of electronic commerce transaction with other company, the electronic commerce transaction entity 14 sends an audit service information provision request a33 to the audit information service 32 of inspector site 5. The audit service information provision request a33 takes the following structural components:

Audit Service Request::={
Entity Identifier Of Requester;
Entity Identifier Of Opposite;
Signature Of Requester;
Key Information;
};

“Entity Identifier Of Requester” in the audit service information provision request a33 means an access point relating to the electronic commerce transaction entity 14 and it is described by URI (Uniform Resource Identifier) which is fixed by the World Wide Web Consortium (W3C). Also, “Entity Identifier Of Opposite” means an access point relating to the electronic commerce transaction entity of estimation/assessment destination, and it is described by URI (Uniform Resource Identifier) which is fixed by the World Wide Web Consortium (W3C), similarly.

“Signature Of Requester” in the audit service information provision request a33 means that a signature is placed on “Entity Identifier Of Requester” and “Entity Identifier Of Opposite” of “Audit Service Request” using the private key of the electronic commerce transaction entity 14. In contrast to this, “Key Information” is information relating to a public key certification corresponding to the private key.

When receiving the audit service information provision request a33, the audit information service 32 verifies “Signature Of Requester”, which is the signature, and confirms that it is the request sent from the electronic commerce transaction entity 14 to extract “Entity Identifier Of Opposite.” Thereafter, the audit information service 32 issues an inquiry request a34 as an argument to the inspect results repository 31 using “Entity Identifier Of Opposite.”

The inspect results repository 31 generates an inquiry request a35 including the latest audit result record a32, latest response reaction/dishonor possibility record a38, latest abnormal response processing ratio audit record a40, and responds to the audit information service 32.

After that, the audit information service 32 responds an audit service information provision response a36 to the electronic commerce transaction entity 14. The audit service information provision response a36 takes the following structural components:

Audit Service Response::={
Entity Identifier Of Requester;
Entity Identifier Of Opposite;
Audit Item [1];
Audit Item [2];
Audit Item [3];
.................................
Signature Of Responsor;
Key Information;
};

“Entity Identifier Of Requester” and “Entity Identifier Of Opposite” in the audit service information provision response a36 are the same as those of the audit service information provision request a33. “Audit Item [1]”, “Audit Item [2]” and “Audit Item [3]” mean the latest audit result record a32, latest response reaction/dishonor possibility record a38, latest abnormal response processing ratio audit record a40, respectively.

“Signature Of Responsor” in the audit service information provision response a36 is that a signature is placed thereon using the private key of inspector site 5 excepting “Signature Of Responsor” and “Key Information” of “Audit Service Response.” In contrast to this, “Key Information” is information relating to a public key certification corresponding to the corresponding private key.

Thus, processing of the electronic commerce transaction audit system of this embodiment is ended.

### Second Embodiment

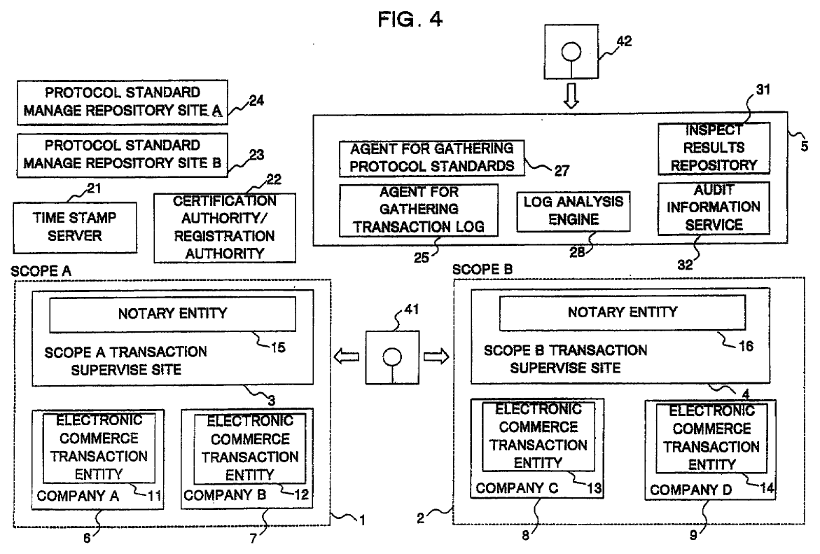

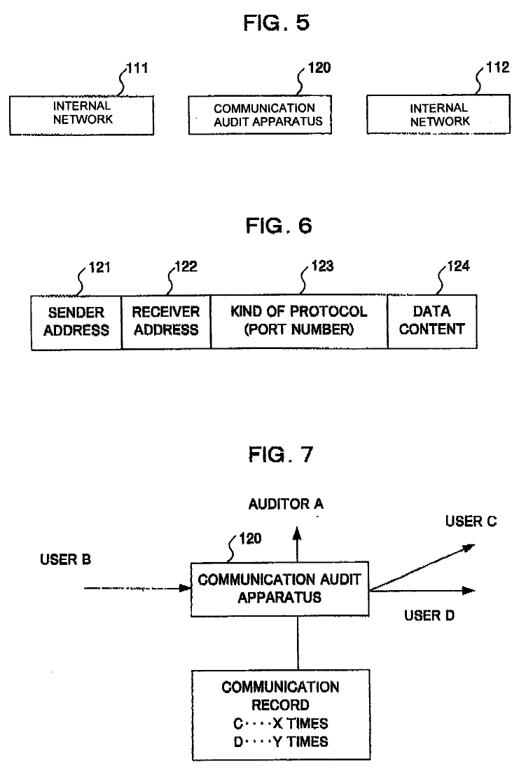

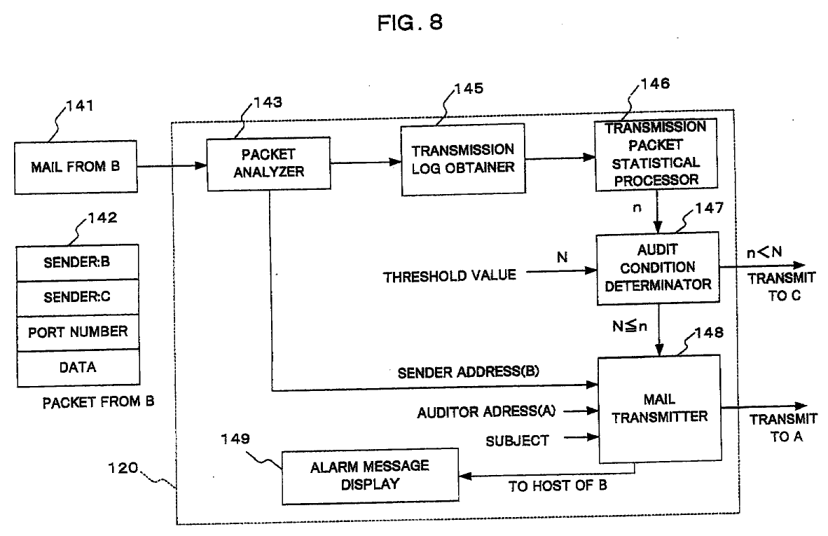

An explanation will be next given of the second embodiment of the present invention with reference to the drawings accompanying herewith. FIG. 4 is a block diagram illustrating the system structure of the present embodiment.

As illustrated in FIG. 4, the present embodiment includes a storage medium 41 and storage medium 42 in addition to the structure of the first embodiment. Here, in FIG. 4, though the specific structure and the flow of information are omitted, it is assumed that the structural components illustrated in this figure are the same as those of FIG. 1. Moreover, it is assumed that information transmitted/received among these structures are completely the same as those of FIG. 1.

In FIG. 4, a program for executing processing, which the scope A transaction supervise site 3 and scope B transaction supervise site 4 should perform, is recorded on the storage medium 41. A program for executing processing, which the inspector site 5 should perform, is recorded on the storage medium 42. The scope A transaction supervise site 3 or scope B transaction supervise site 4 performs the same processing as the first embodiment under control of the program loaded from the storage medium 41 and control of the program loaded from the storage medium 42, respectively.

The storage mediums 41 and 42 may be storage mediums including magnetic disk, semiconductor memory, and so on. Moreover, the program may be divided into a storage medium group including a plurality of storage mediums, and recorded thereon.

Accordingly, the present invention comprises a plurality of electronic notarize means for uniformly stamping time on all exchange messages on the electronic commerce transaction to record and store them. Each electronic notarize means has a function of vying with other electronic notarize means to take a mutual notarization of all exchange messages recorded and stored. This makes it possible to improve reliability of an auditor and the system itself.

Moreover, the present invention comprises agent for gathering transaction log means for automatically collecting all exchange messages notarized and recorded depressively by the plurality of electronic notarize means in connection with the electronic commerce transaction so as to reproduce them as an event of the entire wide network area, agent for gathering protocol standards means for automatically collecting protocols of the specifications on the electronic commerce transaction, whereby correctly grasping an event to be generated in the entire wide network area, and a log analysis engine for comparing the event of the entire wide network area reproduced by the agent for gathering transaction log means with the event to be generated in the entire wide network area grasped by the agent for gathering protocol standards means, whereby carrying out an objective audit. This makes it possible to perform an audit that grasps a wide network area to verify the event.

Still moreover, the present invention comprises agent for gathering transaction log means for automatically collecting all exchange messages notarized and recorded depressively by the plurality of electronic notarize means in connection with the electronic commerce transaction so as to reproduce them as an event of the entire wide network area, agent for gathering protocol standards means for automatically collecting protocols of the specifications on the electronic commerce transaction, whereby correctly grasping an event to be generated in the entire wide network area, and a log analysis engine for comparing the event of the entire wide network area reproduced by the agent for gathering transaction log means with the event to be generated in the entire wide network area grasped by the agent for gathering protocol standards means, whereby carrying out an objective audit. This makes it possible to judge the content of message and perform an audit.

Still moreover, according to the present invention, it is possible to audit whether or not a computer for exchanging a message of each participating organization including companies is mounted in such a manner that satisfies various kinds of requirements on specifications relevant to the electronic commerce transaction and whether or not there is a problem in the processing ability under the environment of electronic commerce transaction implemented by a computer connected to a network.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2000-298939 filed on Sep. 29, 2000 and including specification, claims, drawings and summary. The disclosure of the above Japanese Patent Application is incorporated herein by reference in its entirety.

What is claimed is:

1. An electronic commerce transaction auditing method wherein time that elapses before a response message is returned after receiving a request message is obtained in connection with an event occurred in the entire network area, whereby auditing a respond reaction ability of each electronic commerce transaction entity.
